(19) United States
(12) Patent Application Publication
(10) Pub. No.: US 2006/0184368 A1
(43) Pub. Date: Aug. 17, 2006

(54) Fidelity of physicians' thoughts to digital data conversions

(76) Inventors: Anuthep Benja-Athon, New York, NY (US); Sirikit Benja-Athon, Port Washington, NY (US)

Correspondence Address: ANUTHEP BENJA-ATHON, 210 E 36TH ST., NEW YORK, NY, 10016, US

(21) Appl. No.: 11/327,973

(22) Filed: Jan. 9, 2006

Related U.S. Application Data
(63) Continuation-in-part of application No. 11/114,763, filed on Apr. 27, 2005.
Application No. 11/114,763 is a continuation-in-part of application No. 11/074,236, filed on Mar. 7, 2005.
Application No. 11/114,763 is a continuation-in-part of application No. 11/059,088, filed on Feb. 16, 2005.
(63) Continuation-in-part of application No. 11/255,229, filed on Oct. 21, 2005.

(51) Int. Cl. G10L 17/00; G06Q 10/00

(52) U.S. Cl. 704/246; 705/2

(57) ABSTRACT

A system of administering words, terms and phrases for optimizing the fidelity and accuracy of health and health-care information on patients generated by physicians in the process of transferring the information from physicians' minds to digital voice data to first digital text data derived from the conversions of corresponding digital voice data to first digital text data. The system provides the editions of and additions of second digital text data into first digital text data.

This application is a continuation-in-part of Ser. No. 11/114,763 entitled System of Influencing Health-Care Utilizations filed Apr. 27, 2005 which is a continuation-in-part of Ser. No. 11/074,236 entitled System of Health-Care Resources file Mar. 7, 2005 and Ser. No. 11/059,088 entitled Consumers Buyers-Physicians Health-Care filed Feb. 16, 2005 which are pending, and a continuation-in-part of Ser. No. 11/255,229 entitled the Best Method of Computerized Transcriptions filed on Oct. 21, 2005 is now abandoned due to an Office's Nov. 18, 2005 Notice of Omitted “page 1 of the specification (description and claims)” which applicants chose not to contend.

### FIELD OF INVENTION

A system for optimizing the fidelity of physicians' thoughts to digital texts conversion.

### BACKGROUND OF THE INVENTION

The present invention is a unique and foremost system for preserving the accuracy of and maximizing the outputs on health and health-care information on patients generate within the brains of and by physicians.

Specifically, the present invention is a system of administering words, terms, phrases and sentences use in medical and surgical specialties, health and health-care to achieve the goals of the present invention.

No prior art taught the processes of generating and forming distinct patterns of health and health-care data on patients in physicians' brains or minds and the processes of manipulating and editing the digital text data on said health and health-care data derived from digital voice data comprising said health and health-care data in computers or servers in a network of computers and servers leading to an effective or optimal transfers of accurate said data from said physicians' brains or minds to digital voice data to digital text data in said computers and servers.

Furthermore, prior art computerized conversion of digital audio or voice data produced by a physician to digital text data is estimated to achieve only from 10%-80% accurate conversion. Errors are plentiful. These range of accuracy and abundant errors are unacceptable and not practical. Multiply the above data and number of physicians by several hundred thousands or a few millions per day, the errors produce by prior art are massively large and totally unacceptable and rendering the speech recognition technology in medicine and health-care impractical and useless.

The present invention resolves the above problems and renders the practical use and application of the computerized conversion of digital voice data comprising health and health-care information on patients generate by tens or hundreds of thousands of physicians to corresponding digital text data.

Consequently, the present invention will rapidly cause the widespread applications of the best health-care system for improving the American health-care with all the human and socioeconomic benefits for all Americans and the world as provide by the earlier pending patent applications of these physician applicant and his co-applicants.

However, a fundamental to the rapid achievement of the goals set by said earlier patent applications is the present invention which provides the most effective system of allowing a network of computers and servers to rapidly and accurately produce the products of the thought processes of more than 600,000 American physicians' brains—and those of other health-care providers and physicians in the other parts of the world and other people—into digital data in computer and server means for storing data and in computer means for displaying said data to all parties involved.

The present invention's benefits and benevolent affects on humanity are immense as the present invention will surely cause billions of health-care dollars, tangible and intangible benefits per day to positively affect and improve the lives of millions of people in America and the world.

### SUMMARY OF THE INVENTION

A system of administering words, terms, phrases and sentences use in medical and surgical specialties, health and health-care to produce the optimal transfers of accurate health and health-care information on patients generated in thousands of physicians' and other health-care providers' minds to computers and servers in a network of computers and servers.

The present invention is a system of administering and using words, terms, phrases, word-word, word-phrase and word-term couplings covering all medical and surgical specialties for optimizing the transfers of health and health-care information on patients generated by physicians from physicians' minds to first digital text data wherein said first digital text data are derived from digital voice data comprising said health and health-care information, wherein said digital voice data are converted into first digital text data in computers or servers of a network of computers and servers, wherein said first digital text data are viewed and edited by physicians and wherein second digital text data are added into said first digital text data. Databases comprising dictionaries of words, phrases and terms use in medicine, medical and surgical specialties, health and health-care are provided. A process of matching words, phrases, terms, word-word couplings, word-term couplings and word-phrase couplings in digital voice data with words, phrases, terms, word-word couplings, word-term couplings and word-phrase couplings of databases is provided.

### DESCRIPTION OF THE PREFERRED EMBODIMENTS

The present invention is a system of administering and using words, terms, phrases and sentences use by physicians in about 70 medical and surgical specialties or fields of medicine and surgeries alphabetically from allergy to radiology, health and health-care to optimize the transfers of health and health-care information on patients generated by thousands of physicians by said physicians' brains or minds to thousands or millions of files of first digital text data wherein said first digital text data are derived from digital voice data comprising said health and health-care information.

The descriptions of the preferred embodiments infra apply to thousands of physicians in all medical and surgical specialties, practices or fields of medicine and surgeries, health and health-care.

The process coupling words with words, words with phrases, and words with terms comprising of coupling of two groups of words, phrases and terms which are performed for all or about 70 medical and surgical specialties or practices or fields of medicine and surgeries, health and health-care. First group comprises types, categories, headings or topics in medicine and surgeries such as, but not limited to, Drug Allergy, Food Allergy, Chief Complaint, Diagnosis, Differential Diagnosis, Treatment, Procedure, Prescription, Surgery, Office Visit, Consultation, Test, Recommendation, Referred Physicians, Hospital, Clinics and Messages. Second group comprises words, phrases and terms use in all or about 70 medical and surgical specialties or practices and health and health-care and are in medical and surgical dictionaries, thesauruses and books. Two representations of said couplings are shown infra although tens to hundreds of thousands of couplings covering all medical and surgical specialities and practices, health and health-care can be formed and achieved by said process.

First, in the application of speech recognition technology, the present invention provides a process of displaying databases comprising dictionaries of words, phrases and terms use in medicine, medical and surgical specialties, health and health-care and word-word, word-term and word-phrase couplings comprising said words, terms and phrases to said physicians who are taught how to benefit from the specific arrangements of words, phrases, terms and couplings in said databases. Furthermore, said physicians are taught a process of thinking and articulating said physicians' thoughts based on said specific arrangements of words, phrases, terms and said couplings in databases relating to said physicians' medical or surgical specialties or practices. Said physicians are taught a process of matching words, phrases, terms, sentences and couplings generated by said physicians' brains or minds on said information to approximate or match with words, phrases, terms, sentences couplings in said databases and, consequently, producing and inputting said information into digital voice recorder means for recording said information and converting said information into digital voice data comprising said information.

For example, a neurologist according the neurology dictionary of thousands of words, phrases and terms and using said processes to think and generate said information based on a process of coupling words, a process of coupling words and phrases, a process of coupling words and terms and a process of using said couplings generates health and health-care information on a patients and then dictates into a digital voice recorder the following sample of words, phrases, terms and couplings:

Chief Complaint headache

Diagnosis cervicogenic headache

Differential Diagnosis brain tumor

Treatment trigger point injection

Procedure nerve biopsy

Prescription motrin

Surgery epidural steroid

Test brain scan

Recommendation avoid certain drugs and caffeine, cheeses and wine

Referred Physician dr. james smith.

Similarly, a rheumatologist according the rheumatology dictionary of thousands of words, phrases and terms and using said processes to think and generate said information based on a process of coupling words, a process of coupling words and phrases, a process of coupling words and terms and a process of using said couplings generates health and health-care information on a patients and then dictates into a digital voice recorder the following sample of words, phrases, terms and couplings:

Chief Complaint joint pain

Diagnosis rheumatoid arthritis

Differential Diagnosis osteoarthritis

Treatment joint injection

Prescription gold

Test joint x-ray

Recommendation rest joints and no straining of joint when there is inflammation

Referred Physician dr. james dole

The above settings and processes are repeated for each and all physicians in all or about 70 medical and surgical specialties or practices such as, but not limited to, allergists, endocrinologists, immunologists, gastroenterologists, nephrologists, oncologists, radiologists, general surgeons, plastic surgeons using the present invention every time. Thus, thousands of physicians practicing all or about 70 medical and surgical specialties using about 70 medical and surgical specialty dictionaries of words, terms and phrases and use of tens to hundreds of thousands of word-word, word-term and word-phrase couplings in said databases according to the preferred embodiments of the present invention to achieve the goals and objectives of the present invention.

To achieve supra and infra, the memories or caches of computers and/or servers in the system of computers and servers have medical and surgical dictionaries and thesauruses comprising millions of words, numbers, terms, phrases, codes, labels and said couplings on said medical and surgical specialties and practices to achieve the objectives of the present invention.

Further to supra, it is understood that the above process also comprises a process of using words, phrases, terms, word and word-phrase couplings that are not in a physician's medical or surgical specialty or practice. In other words, in order to effectively communicate, document or record information and to generate meaningful, accurate or correct health and health-care information on a patient and patients by a physician in his/her clinical practice, a physician can and will incorporate non-medical and other medical and surgical words, phrases, terms and said couplings from other medical and surgical specialties outside his/her specialty in the construction of words, phrases, terms, word and word-phrase couplings in the digital data in the claims of the present invention. For example, any physician such as a neurologist can and will generate words, phrases, terms and said couplings relating to his/her neurology specialty or practice and, as necessary, to other medical and surgical specialties such as, but not limited to, endocrinology, rheumatology, orthopaedics, urology, nephrology and pharmacology. Said examples apply to all physicians belonging to all or about 70 medical and surgical specialties and practices such as, but not limited to, allergists, endocrinologists, immunologists, gastroenterologists, nephrologists, oncologists, radiologists, general surgeons and plastic surgeons.

Second, said digital voice data generated by said physicians are inputted into computers and transmitted via a network of computers and servers wherein said digital voice data are converted into first digital text data which are viewed and edited by physicians. Said digital text data are editable or amended at locations and sites in said computers and/or servers.

Furthermore said processes are available to said physicians at locations on displayed pages on computer display screens where physicians can view and edit or amend said digital text data before said digital text data are submitted and rendered fixed or non-editable or unalterable. The present invention provides the method comprising a process of selecting contents of said displayed digital text data and a process of replacing said selections with words, terms and phrases by a process of keyboarding or typing words, terms and phrases derived from said physicians' brains or minds, a process of displaying pop-up menus comprising words, phrases and terms and a process of replacing said words, terms and phrases with said words, phrases and terms from said pop-up menus and combination of all said processes.

For example, in a categories or headings of Chief Complaint . . . Headeight or Diagnosis . . . Fall's palsy may be presented data infidelity in a page of said digital text data to a physician who can use said processes of selecting and replacing said errors to achieve the desired display of Chief Complaint . . . Headache or Diagnosis . . . Bell's palsy. Said processes can be achieved by thousands of physicians using said processes for thousands—millions of files of digital text data for various medical and surgical types, categories, headings or topics such as, but not limited to, Drug Allergy, Food Allergy, Chief Complaint, Diagnosis, Differential Diagnosis, Treatment, Procedure, Prescription, Surgery, Office Visit, Consultation, Test, Recommendation, Referred Physicians, Hospital, Clinics and Messages.

Third, the present invention provides a process of adding second digital text data comprising said types, categories, headings or topics such as, but not limited to, Drug Allergy, Food Allergy, Chief Complaint, Diagnosis, Differential Diagnosis, Treatment, Procedure, Prescription, Surgery, Office Visit, Test, Recommendation, Referred Physicians, Hospital, Clinics and Messages and related data is provided to add electronic data at locations and sites in said computers and/or servers. Furthermore, the present invention also provides said physicians with a process of keyboarding or typing said types, categories, headings or topics and related or relevant words, phrases and terms derived from said physicians' brains or minds, a process of displaying pop-up menus comprising said types, categories, headings or topics, words, phrases and terms and a process of adding said types, categories, headings and/or topics words, terms and phrases from said pop-up menus into spaces related to said types, categories or headings or topics on display screens and combination of all said processes to achieve the goals and objectives of the present invention.

For example, in a setting among thousands of possible settings of the preferred embodiments, a physician may view Drug Allergy, Food Allergy, Diagnosis, Treatment, Procedure, Prescription, Surgery, Office Visit, Test, Recommendation, Referred Physicians, Hospital, Clinics and Messages and related and relevant data on a displayed screens. Said physician can add Chief Complaint and Differential Diagnosis and related and relevant data which are missing from the above. As a result, said physician has Drug Allergy, Food Allergy, Chief Complaint, Diagnosis, Differential Diagnosis, Treatment, Procedure, Prescription, Surgery, Office Visit, Test, Recommendation, Referred Physicians, Hospital, Clinics and Messages and related and relevant data. Said processes can be achieved by thousands of physicians using said processes for thousands—millions of files of digital text data for various medical and surgical types, categories, headings or topics such as, but not limited to, Drug Allergy, Food Allergy, Chief Complaint, Diagnosis, Differential Diagnosis, Treatment, Procedure, Prescription, Surgery, Office Visit, Test, Recommendation, Referred Physicians, Hospital, Clinics and Messages.

It is understood that in order to effectively communicate, document or record information and to generate meaningful, accurate or correct health and health-care information on a patient and patients by a physician in his/her clinical practice, a physician can and will incorporate non-medical and other medical and surgical words, numbers, terms, phrases, sentences, codes and labels from other medical and surgical specialties outside his/her specialty in the construction of terms, phrases and/or sentences in the digital data in the claims of the present invention. For example, any physician such as, but not limited to, a neurologist can and will generate words, numbers, terms, phrases, sentences, codes and labels in his/her neurology specialty or practice and also from other medical and surgical specialties or practices such as, but not limited to, endocrinology, rheumatology, orthopaedics, urology, nephrology, pharmacology and general surgery. Said example and setting applies to each and all physicians practice about 70 medical and surgical specialties.

It is to be understood that specialty and specialties infra also embody or comprise words, numbers, terms, phrases, sentences, codes and labels in pharmacology and pharmaceutics use by physicians and pharmacists such as, but not limited, names of drugs and medications, doses and uses and toxicology such as, but not limited to, names of toxic substances.

It is understood that the preferred embodiments of the present invention apply to all medical and surgical specialties and practices and all other health and health-care specialties, professions and practices even though the above cited all or about 70 medical and surgical specialties and practices or fields of medicine and surgeries, health and health-care as a representation in the description of the preferred embodiments.

It is understood that the preferred embodiments of the present invention apply to other health-care providers and it will be appreciated by those skilled in the art that adaptations and variations may be made in this setting without departing from the spirit of the invention and the scope of the claims.

Although various preferred embodiments of the present invention have been described for patients, physicians and other health-care providers, it will be appreciated by those skilled in the art that adaptations and variations may be made to apply to other businesses and industries such as, but not limited, law, lawyers and government and their clients, veterinarians and animals, engineering and engineers without departing from the spirit of the invention and the scope of the claims.

Although various preferred embodiments of the present invention have been described, it will be appreciated by those skilled in the art that adaptations and variations may be made without departing from the spirit of the invention and the scope of the claims.

1. A system of maintaining the fidelity of health and health-care information on patients generated by physicians in the conversions of digital voice data comprising said health and health-care information into first digital text data in the computers of a network of computers and servers comprises:
databases comprising dictionaries of words, phrases and terms use in medicine, medical and surgical specialties, health and health-care;
databases comprising word-word couplings;
databases comprising word-phrase couplings;
databases comprising word-term couplings;
a process of coupling words;
a process of coupling words and phrases;
a process of coupling words and terms;
a process of using word-word couplings;
a process of using word-phrase couplings;
a process of using word-term couplings;
a process of matching words, phrases, terms, word-word couplings, word-term couplings and word-phrase couplings in digital voice data with words, phrases, terms, word-word couplings, word-term couplings and word-phrase couplings of databases;
a process of displaying databases;
a process of displaying pop-up menus comprising words, phrases and terms use in medicine, medical and surgical specialties, health and health-care;
a process of adding second digital text data; and
a process of editing digital text data.

2. The system according to claim 1 wherein said process of using word-word couplings comprises a process of generating word-word couplings in digital voice data by physicians.

3. The system according to claim 1 wherein said process of using word-phrase couplings comprises a process of generating word-phrase couplings in digital voice data by physicians.

4. The system according to claim 1 wherein said process of using word-term couplings comprises a process of generating word-term couplings in digital voice data by physicians.

5. The system according to claim 1 wherein said process of matching words, phrases, terms, word-word couplings, word-term couplings and word-phrase couplings in digital voice data with words, phrases, terms, word-word couplings, word-term couplings and word-phrase couplings of databases comprises a process of associating a physician's digital voice data generate by said physician with a digital dictionary of words, phrases, terms word-word couplings, word-term couplings and word-phrase couplings relating to said physician's medical or surgical specialty.

6. The system according to claim 1 wherein said process of matching words, phrases, terms, word-word couplings, word-term couplings and word-phrase couplings in digital voice data with words, phrases, terms, word-word couplings, word-term couplings and word-phrase couplings of databases comprises a process of corresponding physicians' digital voice data generate by said physicians with corresponding digital dictionaries of words, phrases, terms word-word couplings, word-term couplings and word-phrase couplings relating to said individual physicians' medical or surgical specialties.

7. The system according to claim 1 wherein said process of editing digital text data comprises a process of editing electronic contents of digital text data.

8. The system according to claim 1 wherein said process of editing digital text data comprises a process of editing digital text data on pages viewable on display screens.

9. The system according to claim 1 wherein said process of editing digital text data comprises a process of displaying pop-up menus comprising words, phrases and terms on display screens.

10. The system according to claim 1 wherein said process of editing digital text data comprises a process of selecting first displayed words, phrases and terms on display screens.

11. The system according to claim 1 wherein said process of editing digital text data comprises a process of replacing selected first displayed words, phrases and terms on display screens with second words, phrases, and sentences.

12. The system according to claim 1 wherein said process of editing digital text data comprises a process of replacing selected first displayed words, phrases and terms on display screens with second words, phrases and terms from pop-up menus comprising words, phrases and terms on display screens.

13. The system according to claim 1 wherein said process of adding second digital text data comprises a process of adding second electronic data to first digital text data.

14. The system according to claim 1 wherein said process of adding second digital text data comprises a process of adding second digital text data into first digital text data.

15. The system according to claim 1 wherein said process of adding second digital text data comprises a process of adding second digital text data into pages of digital text data on display screens.

16. The process of adding second digital text data according to claim 14 includes a process of adding words, phrases, terms and sentences into pages of digital text data on display screens.

17. The process of adding second digital text data according to claim 14 includes a process of adding words, phrases and terms from pop-menus comprising words, phrases and terms into pages of digital text data on display screens.

18. A system of optimizing the outcomes of the conversions of digital voice data comprising health and health-care information on patients generated by physicians into first digital text data wherein said digital voice data are inputted into computers in a network of computers and servers and converted into digital text data which are viewed and edited by physicians comprises:
databases comprising dictionaries of words, phrases and terms use in medicine, medical and surgical specialties, health and health-care;
databases comprising word-word couplings;
databases comprising word-phrase couplings;
databases comprising word-term couplings;
a process of coupling words;
a process of coupling words and phrases;
a process of coupling words and terms;
a process of using word-word couplings;
a process of using word-phrase couplings;
a process of using word-term couplings;
a process of matching words, phrases, terms, word-word couplings, word-term couplings and word-phrase couplings in digital voice data with words, phrases, terms, word-word couplings, word-term couplings and word-phrase couplings of databases;
a process of displaying databases;
a process of displaying pop-up menus comprising words, phrases and terms use in medicine, medical and surgical specialties, health and health-care;
a process of adding second digital text data; and
a process of editing digital text data.

19. A system of administering words, terms and phrases for optimizing the transfers of health and health-care information on patients generated by physicians from physicians' minds to first digital text data wherein said first digital text data are derived from digital voice data comprising said health and health-care information, wherein said digital voice data are converted into first digital text data in computers or servers of a network of computers and servers, wherein said first digital text data are viewed and edited by physicians and wherein second digital text data are added comprises:
databases comprising dictionaries of words, phrases and terms use in medicine, medical and surgical specialties, health and health-care;
databases comprising word-word couplings;
databases comprising word-phrase couplings;
databases comprising word-term couplings;
a process of coupling words;
a process of coupling words and phrases;
a process of coupling words and terms;
a process of using word-word couplings;
a process of using word-phrase couplings;
a process of using word-term couplings;
a process of matching words, phrases, terms, word-word couplings, word-term couplings and word-phrase couplings in digital voice data with words, phrases, terms, word-word couplings, word-term couplings and word-phrase couplings of databases;
a process of displaying databases;
a process of displaying pop-up menus comprising words, phrases and terms use in medicine, medical and surgical specialties, health and health-care;
a process of adding second digital text data; and
a process of editing digital text data.
